(19) United States
(12) Patent Application Publication
(10) Pub. No.: US 2007/0099084 A1
(43) Pub. Date: May 3, 2007

(54) HIGH CAPACITY ELECTRODE AND METHODS FOR ITS FABRICATION AND USE

(75) Inventors: Biying Huang, Ann Arbor, MI (US); Suresh Mani, Ann Arbor, MI (US); Jun Q. Chin, Waterford, MI (US)

Correspondence Address: GIFFORD, KRASS, SPRINKLE,ANDERSON & CITKOWSKI, P.C, PO BOX 7021, TROY, MI, 48007-7021, US

(73) Assignee: T/J Technologies, Inc., Ann Arbor, MI (US)

(21) Appl. No.: 11/554,051

(22) Filed: Oct. 30, 2006

Related U.S. Application Data
(60) Provisional application No. 60/731,716, filed on Oct. 31, 2005.

(51) Int. Cl. H01M 4/58; H01M 4/62; B05D 5/12

(52) U.S. Cl. 429/231.95; 429/232; 429/200; 429/218.1; 427/122

(57) ABSTRACT

A battery electrode comprises an electrically conductive substrate having an electrochemically active electrode composition supported thereupon. The composition includes an active material capable of reversibly alloying with lithium, which material shows a volume change upon such reversible alloying. The composition includes a buffering agent which accommodates the volume change in the active material and minimizes mechanical strain in the composition. The active composition may further include materials such as carbon. The active material may comprise silicon, aluminum, antimony, antimony oxides, bismuth, bismuth oxides, tin, tin oxides, chromium, chromium oxides, tungsten, and tungsten oxides or lithium alloys of the foregoing. The buffering agent may comprise a metal or a metal oxide or lithium alloys of the foregoing. Also disclosed are batteries which incorporate these electrodes, methods for the fabrication of the electrodes and methods for the fabrication and operation of the batteries.

### CROSS-REFERENCE TO RELATED APPLICATIONS

This application claims priority of U.S. Provisional Patent Application Ser. No. 60/731,716 filed Oct. 31, 2005, entitled “High Capacity Electrode and Method for its Fabrication and Use.”

### FIELD OF THE INVENTION

This invention generally relates to electrochemically active materials. More specifically, the invention relates to electrodes, and in particular instances to electrodes having utility as anodes for lithium batteries, and to methods for their fabrication and use.

### BACKGROUND OF THE INVENTION

The anode is an important component of a lithium battery. It is electrochemically active to take up and intercalate or otherwise incorporate lithium during the charge cycle of the battery, and to release lithium when the battery is discharged. In many instances, the uptake and release of lithium can result in volume changes which can cause physical disruption of the electrochemically active material of the anode and thereby compromise its integrity. This loss of integrity will cause battery performance to diminish with repeated charge and discharge cycling. Thus, it will be seen that battery stability and performance will be increased if this loss of integrity of electrode materials can be diminished.

As will be explained in detail hereinbelow, the present invention provides improved electrodes for battery systems. The electrode of the present invention is resistant to degradation caused by volume changes during cycling and hence allows for the fabrication of a lithium battery having a high specific charge storage capacity and long cycle life.

### BRIEF DESCRIPTION OF THE INVENTION

Disclosed herein is an electrode for a lithium battery. The electrode comprises an electrically conductive substrate having an electrochemically active electrode composition supported thereupon. The composition comprises an active material which is capable of reversibly intercalating or otherwise alloying with lithium and which shows a volume change when it so alloys. The composition further includes a buffering agent which is different from the active material and which acts to improve the cycle life of the electrode. In this regard, it is believed that the buffering agent accommodates the volume change in the active material so as to minimize mechanical strain in the composition resulting from reversibly alloying the active material with lithium. In some instances, the composition may further include carbon, and this carbon may, in particular instances, be disposed as a coating on one or more of the active material and the buffering material.

In certain instances, the active material comprises one or more of silicon, tin, an oxide of tin, aluminum, antimony, an oxide of antimony, bismuth, an oxide of bismuth, tungsten, an oxide of tungsten, chromium, and an oxide of chromium. In particular instances, the buffering agent may comprise a metal or an oxide of a metal, and in specific instances, this metal is a transition metal.

The active material may be present in the form of particles, and such particles may, in a particular group of embodiments, have a size in the range of 1 nanometer to 500 microns. The buffering agent may, in some instances, also be present in the form of particles, and in particular instances, these particles may have a size in the range of 10 nanometers to 500 microns. In particular instances, the buffering agent comprises, on a weight basis, 0.1-60% of the electrochemically active composition. The buffering agent may also be electrochemically active in the operation of the battery and as such be capable of taking up and releasing lithium during an operational cycle of a battery.

In some instances, the electrochemically active composition of the present electrodes may be at least partially lithiated prior to the time that it is incorporated into a battery.

Also disclosed herein are methods for fabricating the electrode structures of the present invention. In some instances where the electrochemically active composition includes carbon, the carbon may be formed in situ by pyrolysis of an organic precursor to produce a carbonaceous material, which material may, in some instances, be disposed upon at least some of the particles of the active material and/or the buffer material. In other instances, a carbon coating may be vapor deposited onto particles. While in yet other instances, carbon may be incorporated into the material as a plurality of discrete layers interleaved with other materials.

Further disclosed herein are batteries which incorporate the foregoing electrodes. Also disclosed is a method for operating the disclosed lithium ion batteries wherein the battery is cycled between a first charge state which is less than fully discharged, and a second charge state which is greater than or equal to the first charge state but less than a fully charged state. Operation in this mode minimizes the volume changes and enhances the stability and cycle life of the batteries.

### DETAILED DESCRIPTION OF THE PREFERRED EMBODIMENTS

The electrodes of the present invention include an electrochemically active composition which stores and releases lithium during the cycling of a battery. This electrode composition is typically disposed and supported on a substrate member having good electrical conductivity.

The active composition is comprised, in a large part, of an electrochemically active material which as mentioned above takes up lithium during the charge cycle of the battery, and releases the lithium during discharging. The active material may be in the form of particles. The particles, in one specific instance, have a size in the range of 5-100 nanometers. In particular embodiments, the particles may have a distribution of sizes, and the nominal size stated is an average particle size. In one particular embodiment, the particles have a mean size of approximately 100 nanometers. In other instances, the active material may comprise one or more layers, or it may be present in the form of islands or other such structures.

The composition also includes a buffer material which enhances the cycle life of the electrode. While not wishing to be bound by speculation, the inventors hereof believe that the buffer will operate to accommodate stresses in the composition attendant upon the reversible alloying witch takes place upon charging and discharging. The buffer thus contributes to the stability of the composition. The buffer may also otherwise contribute to the function of the composition. For example, it may operate to enhance the electronic conductivity of the composition. And, in some instances, the buffer material itself may be electrochemically active during the charging and discharging of the battery. The buffer is in some instances present in relatively small amounts such as 0.1-5% on a weight basis, with one particular group of embodiments including approximately 1% by weight of tle buffer. In other instances, relatively large amounts of the buffering agent, up to 80% by weight, are employed; so, in general, the buffering agent may comprise 0.1-80% of the composition on a weight basis. The buffer may be present in the form of particles and the size of the buffer particles is in a typical range of 1-10 microns, and as noted above, the particles may be distributed over a range of sizes. In yet other instances, the buffer may be present in the form of one or more layers, islands, or other such structures.

There are a variety of materials which may be used to fabricate the electrodes. In some instances the active material may be one or more of silicon, tin, an oxide of tin, aluminum, antimony, an oxide of antimony, bismuth, an oxide of bismuth, tungsten, an oxide of tungsten, chromium, or an oxide of chromium, and it is to be understood that these materials may be alloyed with lithium. All of such materials may be used either singly or in combination. As mentioned above, these active materials may be used in the form of particles, or in other instances, they may be disposed as thin layers, islands or other such structures.

Likewise, a variety of materials may be used for the buffer material. In some instances, the buffer material is a metal or a metal oxide which is different from that used as the active material. In particular instances, the buffer material may comprise a transition metal or a transition metal oxide. The buffer material may be comprised of a single material or a mixture of materials such as an alloy, a mixed oxide, or the like. The buffer material may be present in the form of particles. In some instances, the electrochemically active electrode composition may comprise alternating layers of active material and buffering agent disposed in a superposed relationship. Various other continuous as well as discontinuous structures are also contemplated for the electrodes, and such structures may include interdigitated structures, structures including islands of various materials and other configurations which will be apparent to those of skill in the art.

The system of the present invention further include carbon, and this carbon may be present in one or more different forms, and may serve various purposes. For example, carbon may act to enhance tie conductivity of the material. It may also function as an active material which reversibly alloys with lithium. The composition may include carbon in a composite of the active material such as silicon with mesocarbon microbeads MCMB). The carbon may also comprise a carbonaceous coating disposed on at least a portion of the surface of at least some of the active material and/or metal particles. In other instances, carbon particles will be added to the active material which is then typically cast onto a support in the form of a slurry. In yet other instances, the carbon may be present in the form of thin layers or sheets, or as discontinuous islands.

In one group of embodiments, electrodes of the present invention are comprised of a plurality of alternating layers of the active composition (active material and buffering agent) and carbon. For example, a first layer of carbon, such as carbon black, is coated on a conductive substrate such as a copper foil. A layer of the active composition is coated atop the carbon, and a fresh carbon layer is then coated there atop. Subsequent layers of the active composition and carbon are again coated so as to build up an electrode structure. Such structures can include up to one thousand layers depending on particular applications.

In multilayered embodiments of this type, the presence of the carbon layers will enhance the electrical conductivity of the resultant electrode structure, thereby allowing electrodes to be made which include active compositions which have poor electrical conductivity. Thus, through the use of the multilayered embodiment, electrodes which combine high capacity, good conductivity, and high active material loading may be fabricated.

Various methods may be utilized for the preparation of the active electrode composition. According to one general procedure, particles of tile active material and particles of the buffering agent are mixed together with a solution of an organic material such as a monomer or polymer, which organic material is capable of being pyrolyzed to produce a carbonaceous coating. This resultant composition is mixed by ball milling or other processes. Some particular polymers which may be utilized in this regard comprise: PEG, PEO, PAN, PVDF and the like. In one embodiment of the present method, the polymer is dissolved or dispersed in an organic solvent such as IPA or acetone and mixed with the active material and buffering agent. The resulting material is mixed by ball milling, optionally with further solvent, so as to produce a homogeneous mixture. Ball milling is typically carried out for 10 minutes to 50 hours. Following mixing, the solvent is removed by drying at 25° C.-150° C. depending on the solvents used, and the resultant powder mixture is pyrolyzed so as to carbonize the polymer and thereby produce a carbon coating on at least portions of the particles. A typical pyrolysis is carried out at a temperature of approximately 600° C. under a nitrogen atmosphere for approximately 2-8 hours, after which the mixture is cooled to room temperature in an inert atmosphere.

The amount of pyrolyzable polymer incorporated into the mixture is selected so that appropriate carbon levels are derived following pyrolysis. In some variations of the method, carbon may be directly mixed with the active and buffer materials thereby avoiding the pyrolysis step. In other variations of the process, carbon is deposited on particles of the active material and/or the buffering agent by vapor deposition techniques such as chemical vapor deposition, plasma deposition and the like.

In order to fabricate the electrode, the electrochemically active composition is disposed upon a support substrate. The support substrate is electrically conductive and functions to provide mechanical support and stability to the composition as well as provide for the flow of electrical current thereto and therefrom. Typical substrates are comprised of metals and like materials having good electrical conductivity. The substrate may comprise a solid sheet of material or it may comprise a body of mesh, expanded material, perforated material, or other such structure. In one particular instance, the substrate has a roughened surface. Such roughening may be accomplished by mechanical means such as sandpapering, sandblasting or by chemical means such as etching.

In one typical fabrication process, the active composition is pressure bonded to the substrate, optionally with the use of a binder such as a fluorocarbon or other polymeric binder. The amount of the electrode composition disposed upon a substrate will depend upon, at least in part, the performance characteristics required of the electrode. Higher levels of the electrode composition will result in the preparation of electrodes having higher capacities; however, problems of lithium transport and mechanical stability associated with thick layers will impose upper limits on active layer thicknesses.

In other instances the electrode may be fabricated using vapor deposition techniques such as sputtering, evaporation, physical vapor deposition, chemical vapor deposition, and plasma techniques, among others. In such techniques, one or more layers of the materials comprising the electrochemically active composition are disposed on the substrate. As discussed above, the composition may be configured as a plurality of sublayers, a plurality of islands, interpenetrating structures or as a bulk material. All of such structures and methods available in the art may be utilized to prepare the electrodes, in view of the teaching herein.

The present invention was evaluated in a series of experiments wherein anodes prepared according to the methods of the present invention were incorporated into lithium ion batteries, and the batteries were evaluated through a number of charge/discharge cycles. Battery performance was evaluated as a function of initial charge/discharge capacity and cycle number.

In one specific instance, a silicon based electrode was prepared by mixing together 6 grams of 98% pure silicon nano-powder obtained from the Aldrich Chemical Company together with 3.5 grams of MCMB carbon, 0.5 grams of CoO, 1 gram of carbon black (Super P) and 0.6 grams of polyethylene glycol. This mixture was ball milled for 24 hours at room temperature with isopropyl alcohol as a solvent. The solvent was evaporated at 70° C. and the resultant powder heat treated under nitrogen at 600° C. for 2 hours. The resultant electrochemically active composition was then disposed upon electrode supports comprised of copper foil. The supports were roughened with sandpaper to improve adhesion, and the formulation was disposed thereupon at loadings of 0.1 to 6 mg/cm². The approximate weight percent of the coating on the copper foils was as follows: electrochemically active composite: PVDF:carbon=82:8:10 on a weight percent basis.

The performance of these electrodes was then evaluated in lithium test cells. It was found that cells having a capacity of approximately 600 mAh/g, based upon the weight of the active material, had been cycled through over 2500 charge/discharge cycles and still continued to maintain good and stable electrical properties. Similar results have been noted for other cells utilizing these electrodes having discharge capacities of 500 mAh/g and 700 mAh/g. These cells have been found to be very stable throughout their cycle and service life. End of voltage change with cycling at low loading has been found to be less than 4% after 2000 cycles.

In accord with another aspect of the present invention, it has been found that the electrode materials of the present invention may be incorporated in batteries which are advantageously run through a charge/discharge cycle profile wherein the batteries are cycled so that they are discharged through a first charge level which is less than a filly discharged level (which in the case of a Si based electrode in a lithium half-cell corresponds to Li_{4.4}Si) and recharged to a second charge level which is greater than or equal to the first charge level but less than a fully charged level (which in the case of a Si based electrode in a lithium half-cell corresponds to Li₀Si). When the batteries are so operated it has been found that their operation is very stable with no significant degradation.

When the materials of the present invention are utilized in lithium batteries, they operate to take up and release lithium ions, and in some instances it has been found advantageous to at least partially lithiate the materials prior to incorporating them into lithium batteries. Lithiation may be carried out on a finished electrode by chemical and/or electrochemical processes. Alternatively, the material may be lithiated prior to being fabricated into an electrode. Lithiation may be accomplished by an electrochemical or chemical method. For the electrochemical process, the lithium half cells will be discharged under C/10 with cutoff voltages between 0.02 and 2.0 V. In the case of silicon based active materials, this provides an anode composite of LiₓSi, where x ranges from 0 to 4.4. For the chemical method, tie composite is premixed with stoichiometric amounts of lithium metal powder and ball milled in an inert atmosphere and at 600° C. to generate the pre-lithiated species. Pre-lithiation has been found to improve stability and charge/discharge efficiency of the batteries.

It has also been found that the performance of cells and batteries which incorporate the afore-described anodes is even further enhanced by the inclusion of at least partially fluorinated materials in the electrolyte compositions. These materials are believed to enhance the stability of the solid/electrolyte interface layer, and thus enhance the cycle life of the resultant battery. In one particular group of evaluations, fluoroethylene carbonates (FEC) were included in cells incorporating the high capacity composite anodes, and resulted in enhanced cycle life.

While this disclosure has primarily been directed to high capacity composite anodes for lithium batteries, these principles are applicable to cathodes as well as to battery systems other than lithium battery systems.

In view of the teaching presented herein, other modifications and variations of the present invention will be apparent to those of skill in the art. The foregoing is illustrative of specific embodiments of the invention, but is not meant to be a limitation upon the practice thereof. It is the following claims, including all equivalents, which define the scope of the invention.

1. An electrode for a lithium battery, said electrode comprising:
an electrically conductive substrate; and
an electrochemically active electrode composition supported on said substrate, said electrochemically active composition comprising: an active material which is capable of alloying with lithium, and which shows a volume change when it alloys with lithium; and a buffering agent which improves the cycle life of the electrode.

2. The electrode of claim 1, wherein said electrochemically active electrode composition further includes carbon.

3. The electrode of claim 2, wherein said carbon comprises a coating disposed upon at least some of the particles of said active material and/or said buffering agent.

4. The electrode of claim 1, comprising a plurality of layers of said electrically active electrode composition, and a plurality of layers of carbon interposed therebetween, said layers being supported in a stacked relationship upon said substrate.

5. The electrode of claim 1, wherein said active material comprises a member selected from the group consisting oft Si, Sn, an oxide of Sn, Al, Sb, an oxide of Sb, Bi, an oxide of Bi, Cr, an oxide of Cr, W, an oxide of W, combinations thereof, and lithium alloys of the foregoing.

6. The electrode of claim 1, wherein said buffering agent comprises a metal or an oxide of a metal, and said buffering agent is different from said active material.

7. The electrode of claim 1, wherein said buffering agent is a transition metal, an oxide of a transition metal, or a lithium alloy of said metal or oxide, and said buffering agent is different from said active material.

8. The electrode of claim 1, wherein said active material comprises particles having a size in the range of 1 nanometer to 500 microns.

9. The electrode of claim 1, wherein said buffering agent comprises particles having a size in the range of 10 nanometers to 300 microns.

10. The electrode of claim 1, wherein said buffering agent comprises, on a weight basis, 0.1-80% of said electrochemically active composition.

11. The electrode of claim 1, wherein said buffering agent is electrochemically active so as to be capable of taking up and releasing lithium during the operational cycle of a lithium battery incorporating said electrode.

12. The electrode of claim 1, wherein said active material is at least partially lithiated prior to the time that said electrode is first incorporated into a lithium battery.

13. A battery which incorporates the electrode of claim 1.

14. The battery of claim 13, wherein said battery includes an electrolyte which incorporates an at least partially fluorinated carbonate therein.

15. A method of operating the battery of claim 13, said method comprising cycling said battery between a first charge state which is less than or equal to a fully discharged charge state, and a second charge state which is greater than or equal to said first charge state but less than a fully charged state so as to minimize volume change in said electrochemically active composition.

16. An electrode for a lithium battery, said electrode comprising:
an electrically conductive substrate; and
an electrochemically active electrode composition supported upon said substrate, said electrochemically active composition consisting essentially of:
5-98% by weight of particles of silicon, said particles having a size in the range of 1-500 nanometers, said active material being capable of alloying with lithium, and showing a volume change when it so alloys, said active material optionally being at least partially lithiated;
0.1-80% by weight of a buffering agent comprising particles of a transition metal and/or a transition metal oxide, said particles having a size in the range of 0.1-20 microns, said buffering agent being active to improve the cycle life of the electrode; and
optionally 0.1-80% of carbon.

17. A method for fabricating an electrode structure, said method comprising the steps of:
providing an electrochemically active electrode composition, said composition comprising a first, active material which comprises particles of silicon or a lithium alloy of silicon, and a buffering agent which comprises particles of a metal or a metal oxide or a lithium alloy of said metal or oxide; at least a portion of said particles of active material and/or said particles of the buffering agent being coated with carbon;
providing a support substrate; and
supporting said electrochemically active composition on said substrate.

18. The method of claim 17, wherein the step of providing the electrochemically active electrode composition comprises contacting at least a portion of said silicon particles and/or said metal or metal oxide particles with an organic material, and pyrolyzing said organic material so as to produce an at least partial carbonaceous coating on at least some of said particles.

19. The method of claim 17, comprising vapor depositing said carbon onto said particles.

20. The method of claim 17, wherein said active material is LiₓSi, wherein x is in the range of 0 to 4.4.
